(19) United States
(12) Patent Application Publication
(10) Pub. No.: US 2023/0333500 A1
(43) Pub. Date: Oct. 19, 2023

(54) TONER REFILL CARTRIDGE WITH FOLDABLE PLUNGER

(71) Applicant: Hewlett-Packard Development Company, L.P., Spring, TX (US)

(72) Inventors: Jinhwa HONG, Seongnam-si (KR); Jiwon MOON, Seongnam-si (KR); Byeongno JEONG, Seongnam-si (KR); Shinhyup KANG, Seongnam-si (KR); Sungchul AHN, Seongnam-si (KR); Seung il KIM, Seongnam-si (KR)

(73) Assignee: Hewlett-Packard Development Company, L.P., Spring, TX (US)

(21) Appl. No.: 18/027,833

(22) PCT Filed: Sep. 28, 2020
(86) PCT No.: PCT/US2020/053086

§ 371 Date: Mar. 22, 2023

(51) Int. Cl. G03G 15/08

(52) U.S. Cl. CPC G03G 15/0877; G03G 15/0894

(57) ABSTRACT

A toner refill cartridge includes a body to contain toner and having a toner discharge port provided at a first end portion of the body, a memory unit including an external electric contact which faces away from the body, a piston disposed in the body to be movable in a longitudinal direction of the body from a top dead position adjacent to a second end portion of the body to a bottom dead position adjacent to the first end portion to push the toner to the toner discharge port, and a plunger to push the piston in the longitudinal direction and movable to a folded position in which the plunger is parallel with the body and covers the external electric contact and to an extended position in which the plunger is aligned with the piston in the longitudinal direction.

### BACKGROUND

An image forming apparatus using an electro-photographic method forms a visible toner image on a photoconductor by supplying toner to an electrostatic latent image formed on the photoconductor, transfers the toner image via an intermediate transfer medium or directly to a print medium, and then fixes the transferred toner image on the print medium.

A development cartridge contains the toner and provides the toner to the electrostatic latent image formed on the photoconductor to form the visible toner image. When the toner in the development cartridge is all or nearly all consumed, the development cartridge may be removed from a main body of the image forming apparatus, and a new development cartridge may be mounted in the main body. For example, new toner may be refilled in the development cartridge by mounting a toner refill kit (a toner refill cartridge) in a toner refilling portion.

### BRIEF DESCRIPTION OF THE DRAWINGS

FIG. 1 is an exploded perspective view of an example of a toner refill cartridge, according to an example of the disclosure;

FIG. 2 is a perspective view of the example of the toner refill cartridge shown in FIG. 1, which shows a state in which a plunger is located at a folded position, according to an example of the disclosure;

FIG. 3 is a perspective view of the example of the toner refill cartridge shown in FIG. 1, which shows a state in which the plunger is located at an extended position, according to an example of the disclosure;

FIG. 4 is a perspective view of the example of the toner refill cartridge shown in FIG. 1, which shows a state in which the toner is completely discharged, according to an example of the disclosure;

FIG. 5 is a partial exploded perspective view of an example of a toner refill cartridge, showing a state in which a pressing member is located at a first position, according to an example of the disclosure;

FIG. 6 is a partial exploded perspective view of an example of a toner refill cartridge, which shows a state in which a pressing member is located at a second position, according to an example of the disclosure;

FIG. 7 is a schematic configuration diagram of an example of an electro-photographic image forming apparatus, according to an example of the disclosure;

FIG. 8 is a schematic perspective view of the example of the electro-photographic image forming apparatus shown in FIG. 7, according to an example of the disclosure;

FIG. 9 is a perspective view of an example of a toner refilling portion, according to an example of the disclosure;

FIG. 10 is an exploded perspective view of an example of a toner refilling portion, according to an example of the disclosure; and

FIG. 11 shows an example of an electric circuit for detecting whether the toner is completely injected, according to an example of the disclosure.

### DETAILED DESCRIPTION

An electrophotographic image forming apparatus is provided with a development cartridge containing toner. A development cartridge provides the toner to an electrostatic latent image formed on a photoconductor and develops the electrostatic latent image into the visible toner image. In response to complete or nearly complete consumption of the toner contained in the development cartridge, a toner refill cartridge may be mounted in the development cartridge and new toner may be refilled in the development cartridge. A syringe type toner refill cartridge includes a plunger which discharges toner by pushing a piston in a body. Before discharging the toner, the plunger is in a state extended from the body by a stroke of the piston in a longitudinal direction. Accordingly, as a toner refill cartridge has a large size, cost for packaging and distribution may be increased. In addition, an electric contact of a memory unit transmitting information of the toner refill cartridge to the main body of the image forming apparatus is exposed to the outside (an external environment), and accordingly, a memory unit may be damaged during handling processes.

According to examples of the toner refill cartridge disclosed herein, the plunger may be connected to the piston to be movable to a folded position in which the plunger is parallel with the body of the toner refill cartridge and covers the electric contact of the memory unit, and an extended position in which the plunger is aligned with the piston in the longitudinal direction of the body. When the plunger is located at the folded position, a total size of the toner refill cartridge is small, and therefore, packaging cost and distribution cost may be saved. In addition, because the electric contact of the memory unit may be protected by the plunger when the plunger is located at the folded position, damage to the memory unit may be prevented. According to an example of the toner refill cartridge, an elastic force toward the outside of the body is applied to the memory unit. In response to mounting of the toner refill cartridge in the toner refilling portion of the development cartridge, the electric contact of the memory unit and the electric contact of the toner refilling portion are in contact with each other and electrically connected. In this case, as the elastic force toward the outside is applied to the memory unit, the electric contact of the memory unit and the electric contact of the toner refilling portion are stably in contact with each other, and thus, a stable electric connection is made. In a state where the piston is located at the bottom dead position and the toner is completely discharged, the elasticity is released, and the toner refill cartridge may be easily removed from the toner refilling portion. Hereinafter, examples of the toner refill cartridge and the image forming apparatus will be described with reference to the drawings.

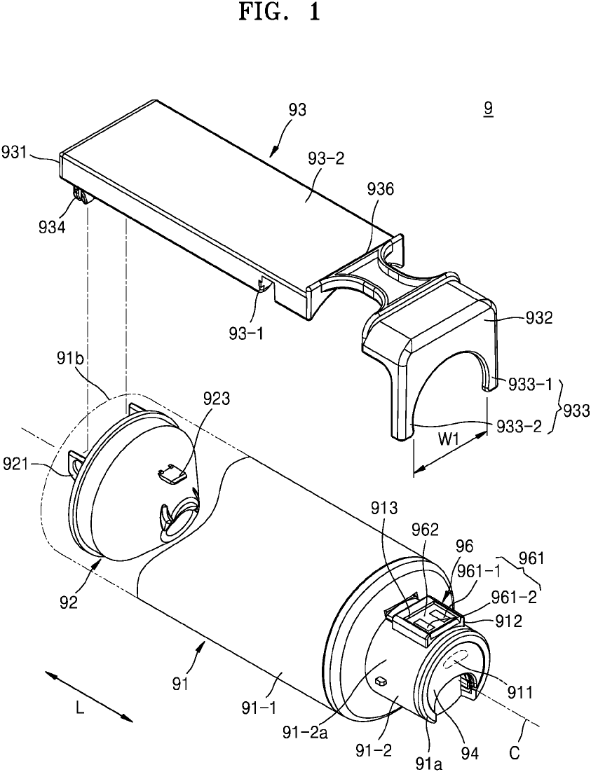

FIG. 1 is an exploded perspective view of an example of a toner refill cartridge 9. Referring to FIG. 1, the toner refill cartridge 9 of the example is a syringe type toner refill cartridge. An example of the toner refill cartridge 9 may include a body 91 containing toner and provided with a toner discharge port 911 discharging toner at a first end portion 91a in a longitudinal direction L, a memory unit 96 including an external electric contact 961 exposed to an outside of the body 91, a piston 92 installed in the body 91 to be movable from a top dead position adjacent to a second end portion 91b in the longitudinal direction L of the body 91 to a bottom dead position adjacent to the first end portion 91a and pushing the toner toward the toner discharge port 911, and a plunger 93 connected to the piston 92, the plunger 93 pushing the piston 92 in the longitudinal direction L and movable to a folded position in which the plunger 93 is parallel to the body 91 and covers the external electric contact 961, and an extended position in which the plunger 93 is aligned with the piston 92 in the longitudinal direction L.

The body 91 may have a cylindrical shape capable of containing toner therein. The body 91 includes the first end portion 91a and the second end portion 91b in a longitudinal direction L. The toner discharge port 911 is provided at the first end portion 91a. As an example, the body 91 may include a first portion 91-1 extending in the longitudinal direction L from the second end portion 91b and containing the toner and a second portion 91-2 extending in the longitudinal direction L from the first portion 91-1 to the first end portion 91a. A cross-sectional area of the second portion 91-2 orthogonal to the longitudinal direction L may be less than a cross-sectional area of the first portion 91-1 orthogonal to the longitudinal direction L. The toner discharge port 911 may be provided in the second portion 91-2. A discharge shutter 94 to open and close the toner discharge port 911 is arranged in the second portion 91-2. As an example, the discharge shutter 94 may be mounted in the second portion 91-2 to be rotated to a discharging position to expose the toner discharge port 911 and a blocking position to block the toner discharge port 911. The discharge shutter 94 may be, for example, rotated by 180 degrees having a central axis C of the body 91 as an axis, and may be switched from the blocking position to the discharge position to open the toner discharge port 911.

The memory unit 96 may include a circuit portion 962 configured to monitor or manage a state of the toner refill cartridge 9 and an external electric contact 961 to be connected with a body of the image forming apparatus to be described later. The circuit portion 962 may include, for example, a customer replaceable unit monitor (CRUM) including a central processing unit (CPU) that executes at least one of authentication and/or encryption data communication with the main body of the image forming apparatus by using an own operating system (O/S). The circuit portion 962 may include a memory. Various kinds of information regarding the toner refill cartridge 9 may be stored in the memory. For example, information regarding the manufacturer, information regarding a manufacturing date, intrinsic information such as a serial number and a model name, various programs, digital signature information and information regarding usage states (for example, the number of sheets of papers that have been printed up to a present time, the number of sheets of paper that are available for printing, and the remaining amount of the toner), and the like. In addition, information regarding the life of the toner refill cartridge 9, set up menus, and the like may also be stored in the memory. In addition, the circuit portion 962 may include functional blocks capable of performing various functions for communication with the main body of the image forming apparatus, authentication, encryption, and the like. The circuit portion 962 may be implemented in the form of a chip including a CPU, the form of a chip including a memory and a CPU, or the form of a printed circuit board on which a chip and circuit devices configured to implement various functional blocks are mounted.

The external electric contact 961 may have various forms to allow electric connection to the main body of the image forming apparatus, for example, a conductive pattern, a modular jack, an elastic terminal, and the like. The external electric contact 961 of the example is a conductive pattern. The external electric contact 961 may include a plurality of electric contacts. The memory unit 96 is supported by the body 91 such that the external electric contact 961 is exposed to an outside of the body 91. For example, the memory unit 96 is provided at the second portion 91-2. A protrusion portion 912 partially protruding outward is provided in the second portion 91-2, and the memory unit 96 may be arranged in the protrusion portion 912. An opening portion 913 is provided in the protrusion portion 912, and the external electric contact 961 is exposed toward outside via the opening portion 913.

The piston 92 is mounted in the body 91 to be movable in the longitudinal direction L. A sealing member configured to prevent leakage of the toner may be provided between the piston 92 and an inner wall of the body 91. While moving from the top dead position to the bottom dead position, the piston 92 pushes the toner contained in the body 91 and discharges the toner through the toner discharge port 911. The top dead position may be a position adjacent to the second end portion 91b of the body 91. In the example, the toner is contained in the first portion 91-1 of the body 91, and the piston 92 is mounted inside the first portion 91-1 and moves from the top dead position to the bottom dead position. The bottom dead position may be a position adjacent to an end portion adjacent to the toner discharge port 911 of the first portion 91-1.

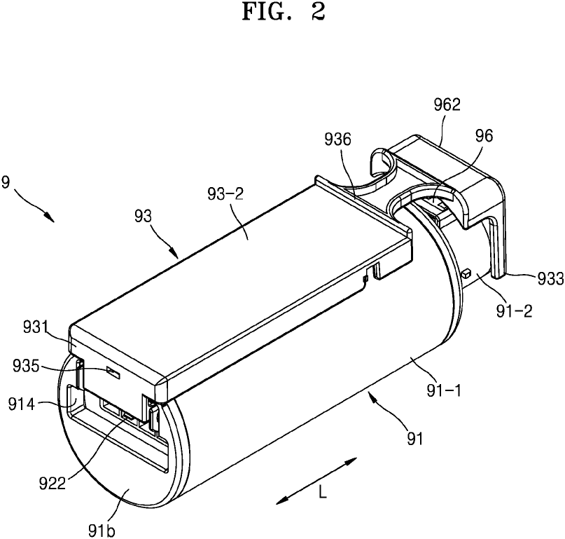

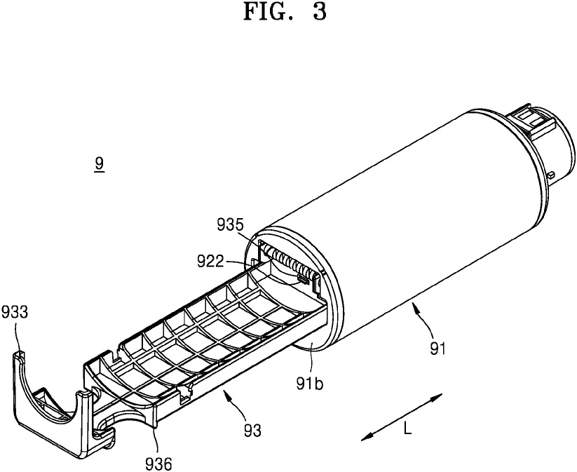

The plunger 93 is connected to the piston 92 to be rotatable to the folded position and the extended position. FIG. 2 is a cross-sectional view of an example of the toner refill cartridge 9 shown in FIG. 1 and illustrates a state in which the plunger 93 is located at the folded position. FIG. 3 is a cross-sectional view of the example of the toner refill cartridge 9 shown in FIG. 1 and illustrates a state in which the plunger 93 is located at the extended position. Referring to FIGS. 1 through 3, a hinge hole 921 may be provided in the piston 92. In a case where the piston 92 is located at the top dead position, the hinge hole 921 is exposed to outside of the body 91 via an opening 914 provided at the second end portion 91b of the body 91. A hinge protrusion 934 inserted into the hinge hole 921 is provided in the plunger 93. The plunger 93 having the hinge protrusion 934 as an axis may be rotated to the folded position and the extending position. As shown in FIG. 2, the folded position is a position at which the plunger 93 extends in the longitudinal direction L in parallel with the body 91. As shown in FIG. 3, the extended position is a position at which the plunger 93 is aligned with the piston 92 in the longitudinal direction L. For example, the plunger 93 may rotate 180 degrees from the folded position and be switched to the extended position. By pushing the plunger 93 in the longitudinal direction L in a state where the plunger 93 is at the extended position, the piston 92, while moving from the top dead position to the bottom dead position, pushes the toner in the body 91 and discharges the toner to outside through the toner discharge port 911.

The plunger 93 includes a first end portion 931, which is provided with the hinge protrusion 934, and a second end portion 932 opposite to the first end portion 931. At the folded position, the second end portion 932 of the plunger 93 is located adjacent to the second portion 91-2 of the body 91. The plunger 93 has a length which is long enough to cover the external electric contact 961 of the memory unit 96 at the folded position. As the plunger 93 at the folded position covers the external electric contact 961 of the memory unit 96, damage to the external electric contact 961 of the memory unit 96 and the memory unit 96 may be prevented in a handling process and distribution process of the toner refill cartridge 9.

At the folded location, the plunger 93 may be provided with a locking portion 933 that is elastically locked at the second portion 91-2 of the body 91. The locking unit 933 may include, for example, a pair of elastic arms 933-1 and 933-2. The pair of elastic arms 933-1 and 933-2 may have the form of circular arcs partially covering the second portion 91-2 of the body 91. A degree of a partial circular arc formed by the pair of elastic arms 933-1 and 933-2 may be slightly greater than 180 degrees. Therefore, a distance W1 between two opposite end portions of the pair of elastic arms 933-1 and 933-2 is slightly less than a diameter of the second portion 91-2. When the plunger 93 rotates from the extended position to the folded position, the pair of elastic arms 933-1 and 933-2 approaches the second portion 91-2 of the body 91. Ends of the pair of elastic arms 933-1 and 933-2 contact an outer circumference of the second portion 91-2 of the body 91. In this state, in a case where the plunger 93 is further rotated toward the folded position, the pair of elastic arms 933-1 and 933-2 are slightly elastically spread outward, and the second portion 91-2 of the body 91 is inserted between the pair of elastic arms 933-1 and 933-2. As the distance W1 between the two opposite ends of the pair of elastic arms 933-1 and 933-2 is slightly less than a diameter of the second portion 91-2, the plunger 93 is elastically locked to the body 91 at the folded position. In this way, the plunger 93 is locked at the folded position by the locking portion 933. The plunger 93 may be stably maintained at a position of covering the external electric contact 961 of the memory 96, and damage to the external electric contact 961 of the memory unit 96 and the memory unit 96 may be prevented in a handling process and distribution process of the toner refill cartridge 9. In addition, at the folded position, as the first end portion 931 of the plunger 93 contacts the second end portion 91b of the body 91, the plunger 93 is not pressed in the longitudinal direction L. Accordingly, in a case where the plunger 93 is at the folded position, the piston 92 may be stably maintained at the top dead position, and toner leakage due to movement of the piston 92 toward the bottom dead position may be prevented.

In the toner refill cartridge 9 of a syringe type, packaging cost and transportation cost of the toner refill cartridge 9 may be dependent on a size of the toner refill cartridge 9. In a case where the toner refill cartridge 9 is distributed in a state where the plunger 93 is located at the extended position, the toner refill cartridge 9 may have a large size, and thus, packaging cost and transportation cost may increase. The toner refill cartridge 9 of the example may be packaged and transported in a state where the plunger 93 is at the folded position. By doing so, the packaging cost and transportation cost of the toner refill cartridge 9 may be reduced.

At the folded position, the plunger 93 may include an internal portion 93-1 facing the body 91 and an external portion 93-2 that is opposite to the internal portion 93-1. The external portion 93-2 may be planar. As the body 91 of the toner refill cartridge 9 is generally cylindrical, in a case where the toner refill cartridge 9 is put on, for example, a table on which the image forming apparatus is placed, the toner refill cartridge 9 may roll and fall under the table. According to the toner refill cartridge 9 of the example, the toner refill cartridge 9 is handled in a state where the plunger 93 is at the folded position. In addition, as the external portion 93-2 of the plunger 93 is planar, in a case where the toner refill cartridge 9 is put on the table such that the external portion 93-2 faces downward, the toner refill cartridge 9 may be stably maintained on the table without rolling.

As described above, in a state where the plunger 93 is located at the extended position, the plunger 93 is pressed in the longitudinal direction L, the piston 92 is moved from the top dead position to the bottom position, and the toner is discharged. To enable the toner to be stably discharged, the plunger 93 may be stably maintained at the extended position. The toner refill cartridge 9 of the example may have a locking structure configured to lock the plunger 93 at the extended position. The locking structure may include a first coupling portion provided in the piston 92 and a second coupling portion that is provided in the plunger 93 and coupled to the first coupling portion in a state where the plunger 93 is located at the extended position and then locks the plunger 93 at the extended position. As an example, referring to FIGS. 2 and 3, the first coupling portion may include, for example, an elastic protrusion 922 protruding from the piston 92 in the longitudinal direction L. The second coupling portion may include, for example, a groove 935 provided at the first end portion 931 of the plunger 93 for the elastic protrusion 922 to be inserted thereinto in a case where the plunger 93 is at the extended position. A length of the elastic protrusion 922 may be determined such that the elastic protrusion 922 has interference with the first end portion 931 of the plunger 93, in a case where the plunger 93 rotates from the folded position to the extended position, and is elastically bent by a small degree and inserted into the groove 935. By doing so, in a case where the plunger 93 is pressed in the longitudinal direction L, the plunger 93 may be stably maintained at the extended position.

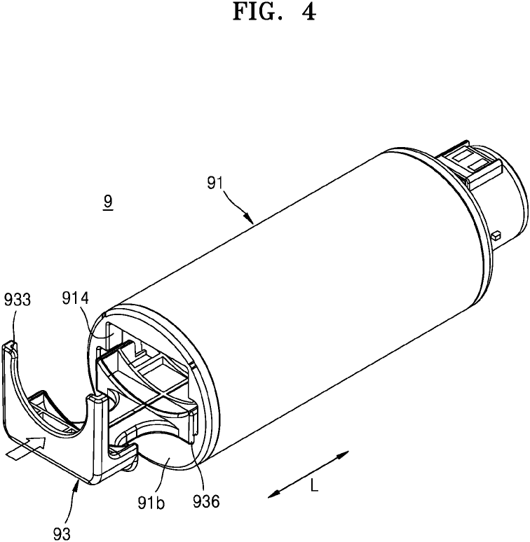

FIG. 4 is a cross-sectional view illustrating a state in which toner discharge is completed in the example of the toner refill cartridge 9 shown in FIG. 1. In the state shown in FIG. 3, the piston 92 may be moved from the top dead position to the bottom dead position by pushing the plunger 93 in the longitudinal direction L. As the piston 92 is moved from the top dead position to the bottom dead position, the plunger 93 is inserted from the first end portion 931 into the body 91 through the opening 914 provided in the second end portion 91b of the body 91. In the plunger 93, a movement limiting protrusion 936 is provided, the movement limiting protrusion 936 contacting the second end portion 91b of the body 91 in a case where the piston 92 is at the bottom dead position. As shown in FIG. 4, in a case where the movement limiting protrusion 936 contacts the second end portion 91b of the body 91, the plunger 93 may not be pressed any further in the longitudinal direction L. Accordingly, the piston 92 may not be moved in the longitudinal direction L beyond the bottom dead position. In addition, in a case where the movement limiting protrusion 936 contacts the second end portion 91b of the body 91, the user may recognize that the toner is completely discharged and may stop pressing the plunger 93.

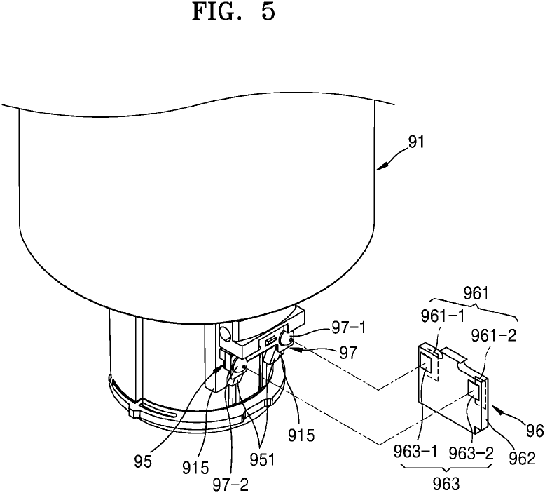

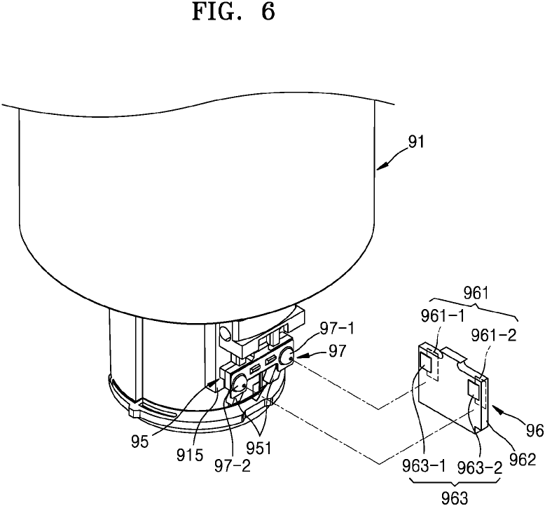

FIG. 5 is a partial exploded perspective view of an example of the toner refill cartridge 9 and illustrates a state in which the pressing member 95 is located at the first location. FIG. 6 is a partial exploded perspective view of an example of the toner refill cartridge 9 and illustrates a state in which the pressing member 95 is located at the second location. FIGS. 5 and 6 are perspective views of a state in which a cover 91-2a (see FIG. 1) covering the second portion 91-2 of the body 91 is removed. Referring to FIGS. 5 and 6, an example of the toner refill cartridge 9 includes a pressing member 95 that is supported by the body 91 to be movable to the first position, at which the memory unit 96 is elastically pressed, and the second position at which the pressing force is removed. The piston 92 is provided with a pressing protrusion 923 (see FIG. 1) that moves (pushes) the pressing member 95 from the first position to the second position in a case where the piston 93 reaches the bottom dead position.

The pressing member 95 is interposed between the body 91 and the memory unit 96. Before the piston 92 reaches the bottom dead position, the pressing member 95 is located at the first position, as shown in FIG. 5. An electric conductor 97 may be disposed between the pressing member 95 and the memory unit 96. The electric conductor 97 is supported by the pressing member 95 to be movable from the first position to the second position together with the pressing member 95. At the first position, the pressing member 95 may elastically push the memory unit 96 outward while the electric conductor 97 is interposed therebetween. For example, the pressing member 95 may include a pair of elastic arms 951. At the first position, the pair of elastic arms 951 are supported by a supporting portion 915 provided in the body 91 and elastically bent. By doing so, the pressing member 95 pushes the memory unit 96 outside while the electric conductor 97 is interposed therebetween. In response to the arrival of the piston 92 at the bottom dead position (or movement of the piston 92 to the bottom dead position), a pressing protrusion 923 of the piston 92 pushes the pressing member 95 in the longitudinal direction L. By doing so, as shown in FIG. 6, the pressing member 95 slides in the longitudinal direction L and moves from the first position to the second position. At the second position, the pair of elastic arms 951 are apart (become separated) from the supporting portion 915 provided in the body 91. That is, the pair of elastic arms 951 escape from the supporting portion 915. Accordingly, the pair of elastic arms 951 is recovered to its original shape, and a pushing force applied to the memory unit 96 is released.

In a case where the piston 92 is at the top dead position, the memory unit 96 is pressed outward by the pressing member 95 at the first position, and therefore, the memory unit 96 may be maintained at a stable position without moving. Accordingly, in a case where the toner refill cartridge 9 is mounted in the body of the image forming apparatus for refilling toner, an electric contact provided in the body may stably contact the external electric contact of the memory unit 96. In addition, as the pressing member 95 is moved to the second position after the toner is completely injected, the pressing force is released. Therefore, the toner refill cartridge 9 may be easily removed from the main body of the image forming apparatus with a small force. Functions and effects of the pressing member 95 will be described in detail later.

Referring to FIGS. 5 and 6, the memory unit 96 includes the external electric contact 961 exposed to an outside of the body 91 and an internal electric contact 963 located so as to face towards the body 91. The internal electric contact 963 is electrically connected to the external electric contact 961. For example, the internal electric contact 963 and the external electric contact 961 are respectively provided at an inner surface and an outer surface of the circuit portion 962 and may be electrically connected to each other by an unshown conductive pattern provided in the circuit portion 962. As shown in FIG. 5, in a case where the pressing member 95 is located at the first position, the electric conductor 97 contacts the internal electric contact 963. As shown in FIG. 6, in a case where the pressing member 95 is located at the second position, the electric conductor 97 moves apart from the internal electric contact 963.

Whether the piston 92 is arrived at the bottom dead position, that is, whether the toner is completely discharged, may be detected according to whether the electric conductor 97 and the internal electric contact 963 contact each other. For example, referring to FIGS. 5 and 6, the external electric contact 961 may include a first external contact 961-1 and a second external contact 961-2. The internal electric contact 963 may include a first internal contact 963-1 and a second internal contact 963-2 which are respectively electrically connected to the first external contact 961-1 and the second external contact 961-2. A first contact portion 97-1 and a second contact portion 97-2 facing the first internal contact 963-1 and the second internal contact 963-2 may be provided in the electric conductor 97. As shown in FIG. 5, in a case where the pressing member 95 is located at the first position, the first contact portion 97-1 and the second contact portion 97-2 contact the first internal contact 963-1 and the second internal contact 963-2, and thus, the first internal contact 963-1 and the second internal contact 963-2 are electrically connected to each other by the electric conductor 97. As shown in FIG. 6, in a state where the pressing member 95 is located at the second location, the first contact portion 97-1 and the second contact portion 97-2 move away from the first internal contact 963-1 and the second internal contact 963-2, and thus, the first internal contact 963-1 and the second internal contact 963-2 are electrically separated from each other. That is, the electric conductor 97 may function as a switch electrically to connect/separate the first internal contact 963-1 and the second internal contact 963-2 to/from each other. Whether the first internal contact 963-1 and the second internal contact 963-2 are electrically connected to/separate from each other may be detected from an output signal of an electric circuit including the first external contact 961-1 and the second external contact 961-2. Accordingly, whether the piston 92 is arrived at the bottom dead position, that is, whether the toner is completely discharged, may be detected by the first external contact 961-1 and the second external contact 961-2.

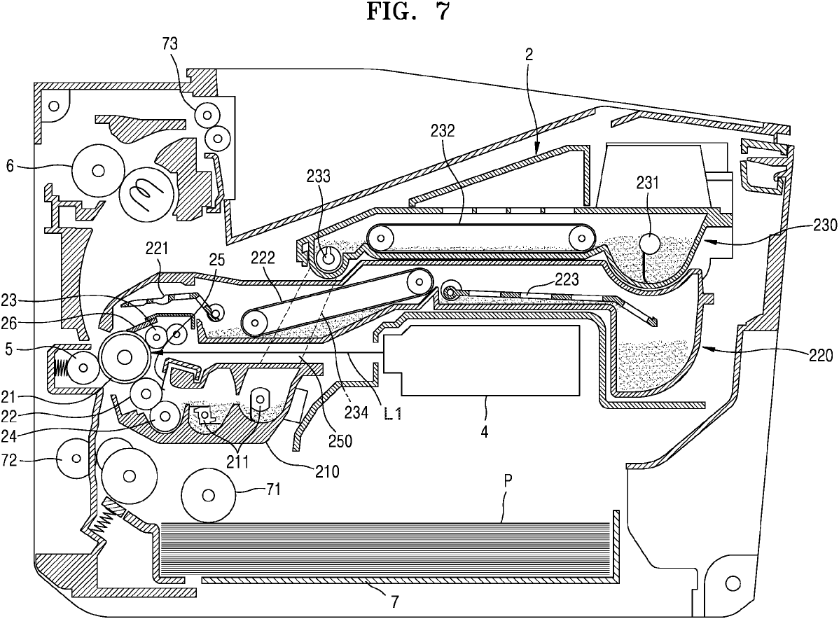

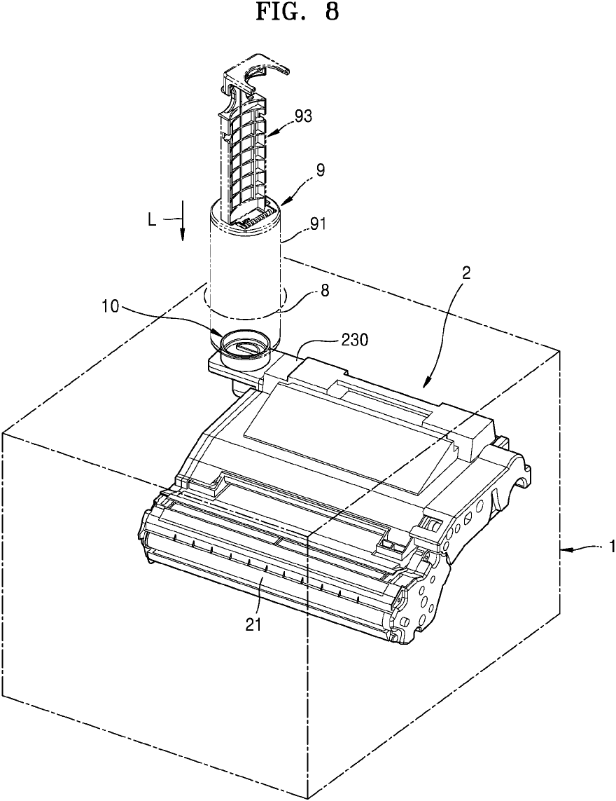

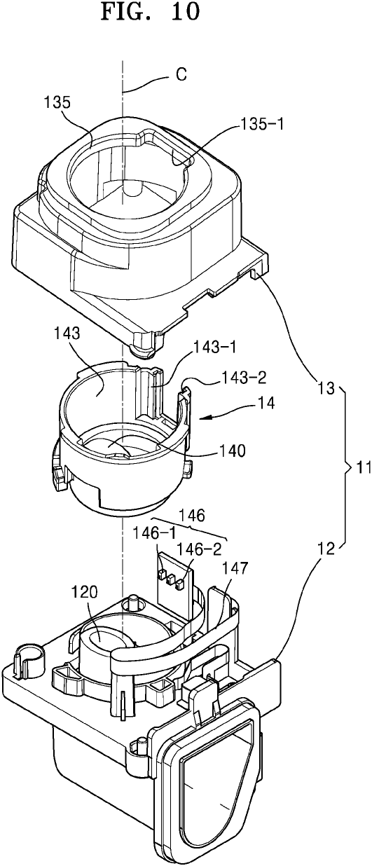

Hereinafter, examples of the image forming apparatus employing the toner refill cartridge 9 will be described. FIG. 7 is a schematic configuration diagram of an example of an electro-photographic image forming apparatus. FIG. 8 is a schematic perspective view of the example of the electro-photographic image forming apparatus shown in FIG. 7. Referring to FIGS. 7 and 8, the example of the image forming apparatus includes a body 1 provided with a communicating portion 8, a development cartridge 2 to form a visible toner image by providing the toner contained in the toner container 230 to the photoconductive drum 21 (the photoconductor) to form a visible toner image, the toner refilling portion 10 including the elastic electric contact 146 (see FIG. 10) and being connected to the toner container 230, and the toner refill cartridge 9 that is mounted in the toner refilling portion 10 via the communicating portion 8 for refilling the toner in the toner container 230. The toner refill cartridge 9 is the same as described with reference to FIGS. 1 through 6.

The development cartridge 2 may be mounted in/removed from the main body 1. For example, after opening a door (not shown) opening and closing a portion of the main body 1, the development cartridge 2 may be mounted in/removed from the main body 1. The development cartridge 2 may include the developing portion 210, in which the photoconductive drum 21 and the developing roller 22 are mounted, a waste toner container 220 to contain the waste toner removed from the photoconductive drum 21, and the toner container 230 connected to the developing portion 210 and containing the toner. To refill the toner in the toner container 230, the development cartridge 2 may include a toner refilling portion 10 connected to the toner container 230. The toner refilling portion 10 provides an interface between the toner refill cartridge 9 and the development cartridge 2. The development cartridge 2 may be an integral-type development cartridge including the developing portion 210, the waste toner container 220, the toner container 230, and the toner refilling portion 10. One or more conveying members 211 to convey the toner to the developing roller 22 may be arranged in the developing portion 210. The conveying member may agitate the toner to charge the toner to have a predetermined electric potential. The waste toner container 220 is apart from the developing portion 210 in an upward direction and forms a light path 250 of exposure light L1 irradiated from an optical scanner 4 to the photoconductive drum 21 between the waste toner container 220 and the developing portion 210. The waste toner removed from the photoconductive drum 21 by a cleaning member is contained in the waste toner container 220. The waste toner is transported into the waste toner container 220 by one or more waste toner transporting members 221, 222, and 223. The toner container 230 contains the toner and is connected to the developing portion 210 by a toner supplying portion 234, as shown by broken lines in FIG. 7. The toner supplying portion 234 is located outside of an effective width of exposure light L1, thereby avoiding interference with the exposure light L1 that is scanned in a main scanning direction by the optical scanner 4. One or more toner supply members 231, 232, and 233 to supply the toner to the developing portion 210 through the toner supplying portion 234 may be arranged in the toner container 230. The toner supply member 233 may convey the toner in the main scanning direction and deliver the toner to the toner supplying portion 234.

A charging bias voltage is applied to a charging roller 23, and the photoconductive drum 21 is charged to have a uniform electric potential. The optical scanner 4 scans light, which is modulated to correspond to the image information, to the photoconductive drum 21 and forms the electrostatic image on the surface of the photoconductive drum 21. The supply roller 24 attaches the toner to the surface of the developing roller 22. The regulating member 25 forms a toner layer of a uniform thickness on the surface of the developing roller 22. A developing bias voltage is applied to the developing roller 22. As the developing roller 22 rotates, the toner conveyed to a development nip is transported to the electrostatic latent image formed on the surface of the photoconductive drum 21 due to the developing bias voltage and attached to the electrostatic image, and a visible toner image is formed on the surface of the photoconductive drum 21. The print medium P withdrawn from a medium supply unit 7 by the pickup roller 71 is fed to the transfer nip, in which the transfer roller 5 and the photoconductive drum 21 face each other, by a feed roller 72. In a case where a transfer bias voltage is applied to the transfer roller 5, the toner image is transferred to the print medium P due to electrostatic attraction. As the toner image transferred to the print medium P receives heat and pressure from a fixing unit 6 and is fixed on the print medium P, printing is completed. The print medium P is discharged by a discharge roller 73. The toner that is not transferred to the print medium P and remains on the surface of the photoconductive drum 21 is removed by the cleaning member 26.

When the toner contained in the toner container 230 is completely consumed, new toner may be refilled in the toner container 230 by using the toner refill cartridge 9. The image forming apparatus according to examples disclosed herein has a structure of locating the plunger 93 at the extended position, inserting the toner refill cartridge 9 from outside into inside of the body 1 and mounting the toner refill cartridge 9 in the toner refilling portion 10, and separating the toner refill cartridge 9 after refilling the toner in the toner container 230 by pressing the plunger 93. The communicating portion 8 enables the toner refill cartridge 9 to access, from outside of the main body 1, the toner refilling portion 10 which is provided inside the main body 1. After the toner is refilled, the toner refill cartridge 9 is removed from the communicating portion 8. According to this configuration, the toner may be refilled in the toner container 230 through the toner refilling portion 10. Therefore, a replacement point of the development cartridge 2 may be extended until the photoconductive drum 21 reaches its end of use, and a printing cost per sheet may be reduced. The toner may be refilled in a state where the development cartridge 2 is mounted in the main body 1, and therefore, user convenience may be improved.

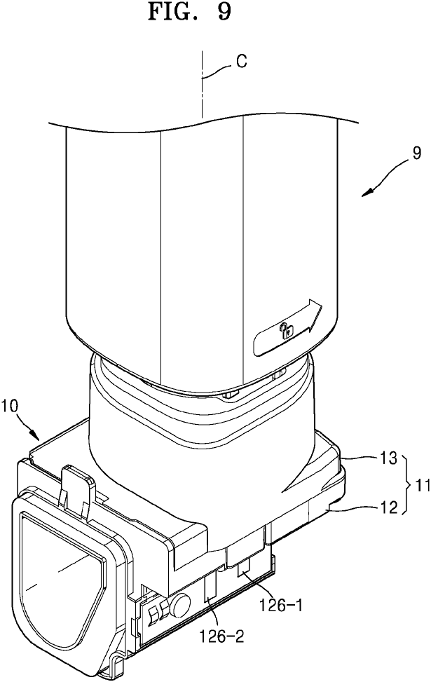

FIG. 9 is a perspective view of an example of the toner refilling portion 10, and FIG. 10 is an exploded perspective view of an example of the toner refilling portion 10. Referring to FIGS. 9 and 10, the toner refilling portion 10 may include a mounting portion 11, on which the toner refill cartridge 9 is mounted, a toner inflow portion 120, and an inflow shutter 14.

The mounting portion 11 includes the toner inflow portion 120 connected to the toner container 230. The toner refill cartridge 9 inserted from the outside of the main body 1 through the communicating portion 8 is mounted on the mounting portion 11. The toner inflow portion 120 is provided in the mounting portion 11 to receive the toner from the toner refill cartridge 9. For example, the mounting portion 11 may include a lower body 12 and an upper body 13. The upper body 13 is combined with the lower body 12. The lower body 12 is connected to the toner container 230. The toner inflow portion 120 is provided in the lower body 12. The mounting portion 11 accommodates the toner refill cartridge 9. For example, the mounting portion 11 may accommodate the second portion 91-2 of the body 91 of the toner refill cartridge 91.

The inflow shutter 14 is provided in the mounting portion 11 to be rotatable to the blocking position to block the toner inflow portion 120 and an inflow position to open the toner inflow portion 120. As an example, the inflow shutter 14 may be supported by the lower body 12 to be rotatable to a blocking position at which the blocking portion 140 blocks the toner inflow portion 120 and an inflow portion at which the blocking portion 140 is displaced with the toner inflow portion and opens the toner inflow portion 120.

The inflow shutter 14 rotates together with the toner refill cartridge 9. For example, the second portion 91-2 of the toner refill cartridge 9 is accommodated in an accommodating portion 143 of the inflow shutter 14. A shape of the first end portion 91a of the toner refill cartridge 9 may be a shape complementary to a shape of the blocking portion 140. The accommodating portion 143 may be provided with an extending portion 143-1 that is partially open and extends outwards to receive the protrusion portion 912 of the toner refill cartridge 9. The upper body 13 may be provided with an insertion portion 135 and a key groove 135-1 respectively aligned with the accommodating portion 143 and the extending portion 143-1. The accommodating portion 143 and the extending portion 143-1, and the insertion portion 135 and the key groove 135-1 are aligned with one another in a case where the inflow shutter 14 is located at the blocking position.

In a state where the inflow shutter 14 is located at the blocking position, the toner refill cartridge 9 may be mounted in the mounting portion 11 by aligning the protrusion portion 912 with the key groove 135-1. By doing so, the second portion 91-2 of the body 91 is accommodated in the accommodating portion 143 of the inflow shutter 14, the protrusion portion 912 is accommodated in the extending portion 143-1, and the first end portion 91a and the blocking portion 140 of the toner refill cartridge 9 are complimentarily combined with each other. The blocking portion 140 covers the toner inflow portion 120. The toner discharge port 911 of the toner refill cartridge 9 is located at a position displaced with the toner inflow portion 120 and is blocked by the discharge shutter 94. In this state, when the toner refill cartridge 9 is rotated, the inflow shutter 14 rotates together with the toner refill cartridge 9. Accordingly, the inflow shutter 14 may rotate to the blocking position and the inflow position. In case the toner refill cartridge 9 rotates and the inflow shutter 14 moves out of the blocking position, the protrusion portion 912 is located below an edge of the insertion portion 135 of the upper body 13, and therefore, the toner refill cartridge 9 is not separated from the mounting portion 11. When the toner refill cartridge 9 rotates, for example, about by 180 degrees, the inflow shutter 14 is located at the inflow position and the blocking portion 140 is displaced from the toner inflow portion 120, and thus, the toner inflow portion 120 is open. The toner inflow portion 120 and the discharge shutter 94 may have complementary shapes such that the discharge shutter 94 does not rotate and the body 91 rotates in the toner refill cartridge 9. Accordingly, while the toner refill cartridge 9 rotates by 180 degrees, the discharge shutter 94 is locked at an outer shape of the toner inflow portion 120 and does not rotate, and the body 91 relatively rotates by 180 degrees with respect to the discharge shutter 94. The toner discharge port 911 of the toner refill cartridge 9 is open, and the toner discharge port 911 is aligned with the toner inflow portion 120. By pushing the plunger 93 in this state, the toner may be supplied from the body 91 to the toner container 230 through the toner discharge port 911 and the toner inflow portion 120.

Electric connection between the toner refill cartridge 9 and the toner refilling portion 10 is described. An elastic electric contact 146 electrically connected to the memory unit 96 of the toner refill cartridge 9 is provided in the toner refilling portion 10. The elastic electric contact 146 may be in the mounting groove 143-2 of the inflow shutter 14. In a case where the toner refill cartridge 9 is mounted in the toner refilling portion 10 in a state where the plunger 93 is located at the extended position, the elastic electric contact 146 elastically contacts the external electric contact of the memory unit 96.

According to the example, as described above, before pressing the plunger 93, that is, in a state where the piston 92 is located at the top dead position, the pressing member 95 is located at the first position and pushes the memory unit 96 outward while the electric conductor 97 is interposed therebetween, as shown in FIG. 5. Accordingly, the memory unit 96 is pressed toward the elastic electric contact 146, and the external electric contact 961 and the elastic electric contact 146 may stably and electrically contact with each other. In a case where the piston 92 arrives at the bottom dead position by pressing the plunger 93, the pressing member 95 is pressed by a pressing protrusion 923 provided in the piston 92 and moved to the second position, as shown in FIG. 6. By doing so, the pressing force applied to the memory unit 96 is released, and the toner refill cartridge 9 may be removed from the toner refilling portion 10 with a small force.

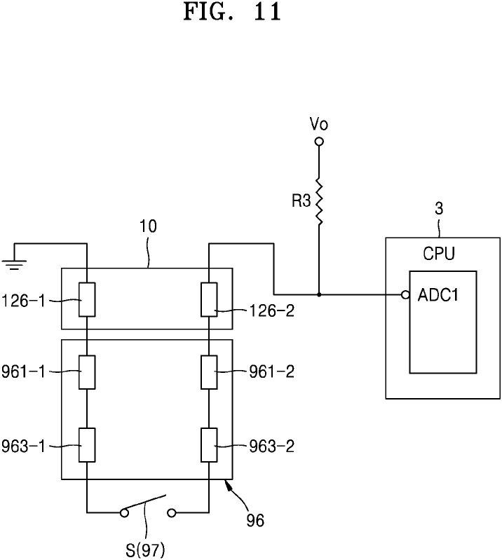

The electric conductor 97 moves to the first position and the second position together with the pressing member 95. This type of configuration may be applied to a structure for detecting whether the toner is completely injected. FIG. 11 shows an example of an electric circuit for detecting whether the toner is completely injected. Referring to FIG. 11, the first internal contact 963-1 and the second internal contact 963-2 of the memory unit 96 and the first external contact 961-1 and the second external contact 961-2 of the memory unit 96 are electrically connected. For example, the first internal contact 963-1 and the first external contact 961-1 may be electrically connected in series with each other, and the second internal contact 963-2 and the second external contact 961-2 may be electrically connected in series with each other. Further, the first internal contact 963-1 and the second internal contact 963-2 may be electrically connected in series with each other via the electric conductor 97 according to whether the electric conductor 97 is in contact with the first internal contact 963-1 and the second internal contact 963-2. The external electric contact 961 is electrically connected to the main body 1, for example, a controller 3 provided in the main body 1, via a first elastic electric contact 146-1 and a second elastic electric contact 146-2, a flexible cable 147, a first contact terminal 126-1, and a second contact terminal 126-2. The controller 3 may be implemented by various electrical components and an electric circuit for controlling an image forming process. FIG. 11 briefly shows a configuration of detecting whether the toner of the toner refill cartridge 9 is completely injected. The controller 3 may include a CPU.

The electric conductor 97 provided in the toner refill cartridge 9 may be modeled as a switch S connecting/separating the first and second internal contacts 963-1 and 963-2 to/from each other. The switch S may be in an ON or OFF state according to whether the piston 92 reached the bottom dead portion 92, and vice versa. For example, in a case where the piston 92 does not arrive at the bottom dead position, the first internal contact 963-1 and the second internal contact 963-2 are electrically connected to each other by the electric conductor 97. That is, the switch S is ON. In response to the arrival of the piston 92 at the bottom dead position, the electric conductor 97 moves away from the first internal contact 963-1 and the second internal contact 963-2, and thus, the first internal contact 963-1 and the second internal contact 963-2 are electrically separated (disconnected) from each other. The switch S is OFF. Electric states of the first internal contact 963-1 and the second internal contact 963-2 may be delivered to the controller 3. The electric states of the first internal contact 963-1 and the second internal contact 963-2 may be detected by various structures. For example, in FIG. 11, in a case where the piston 92 does not arrive at the bottom dead position, the switch S is ON, and a current flows through an electric circuit including the switch S. By doing so, voltage drop occurs due to a resistance R3 and a 0 V voltage is applied to an input port ADC1 of the controller 3. For example, in FIG. 11, in a case where the piston 92 arrives at the bottom dead position, the switch S is OFF, and a current does not flow through the electric circuit including the switch S. As voltage drop does not occur at the resistance R3, a voltage Vₒ, for example, a voltage of 3.3 V, is directly applied to the input port ADC1 of the controller 3. Accordingly, the controller 3 may detect whether the toner is injected based on changes in the voltage applied to the input port ADC1.

Although the disclosure is described with reference to examples shown in the drawings, the description is merely illustrative, and it will be understood that various modifications and equivalent examples thereof are available. Accordingly, the technical scope of the disclosure is to be determined according to the following claims.

What is claimed is:

1. A toner refill cartridge, comprising:
a body to contain toner and having a toner discharge port provided at a first end portion of the body;
a memory unit including an external electric contact which faces away from the body;
a piston disposed in the body to be movable in a longitudinal direction of the body from a top dead position adjacent to a second end portion of the body to a bottom dead position adjacent to the first end portion to push the toner to the toner discharge port; and
a plunger to move the piston in the longitudinal direction and movable to a folded position in which the plunger is parallel with the body and covers the external electric contact and to an extended position in which the plunger is aligned with the piston in the longitudinal direction.

2. The toner refill cartridge of claim 1, wherein
the piston includes a first coupling portion, and
the plunger includes a second coupling portion coupled to the first coupling portion to lock the plunger at the extended position when the plunger is moved to the extended position.

3. The toner refill cartridge of claim 1, wherein
the body includes a first portion to contain the toner, and a second portion which extends in the longitudinal direction from the first portion and including the toner discharge port, and
the plunger includes a locking portion to be elastically locked with the second portion when the plunger is moved to the folded position.

4. The toner refill cartridge of claim 3, wherein
the second portion includes the memory unit.

5. The toner refill cartridge of claim 1, wherein
the plunger includes a movement limiting protrusion to contact the second end portion of the body when the piston is moved to the bottom dead position.

6. The toner refill cartridge of claim 1, wherein
the plunger includes an internal portion facing the body and an external portion facing away from the body, when the plunger is in the folded position, and
the external portion is planar.

7. The toner refill cartridge of claim 1, further comprising
a pressing member supported by the body to be movable to a first position at which the memory unit is elastically pressed and a second position at which a pressing force applied to the memory unit is released, wherein
the piston includes a pressing protrusion to move the pressing member from the first position to the second position when the piston is moved to the bottom dead position.

8. The toner refill cartridge of claim 7, further comprising
an electric conductor supported by the pressing member, wherein
the memory unit includes an internal electric contact which faces toward the body and is electrically connected to the external electric contact, and
the electric conductor is to contact the internal electric contact when the pressing member is at the first position and is to be separated from the internal electric contact when the pressing member is at the second position.

9. An image forming apparatus, comprising:
a main body provided with a communicating portion;
a photoconductor;
a development cartridge to form a visible toner image by providing toner contained in a toner container to an electrostatic latent image formed on the photoconductor;
a toner refilling portion, connected to the toner container, including an electric contact; and
a toner refill cartridge mountable to the toner refilling portion via the communicating portion, the toner refill cartridge including:
a body to contain toner and having a toner discharge port, provided at a first end portion of the body, through which the toner contained in the body is dischargeable into the toner container when the toner refill cartridge is mounted to the toner refilling portion,
a memory unit including an external electric contact to contact the electric contact when the toner refill cartridge is mounted to the toner refilling portion, and
a pressing member supported by the body to be movable to a first position at which the memory unit is elastically pressed and a second position at which a pressing force applied to the memory unit is released.

10. The image forming apparatus of claim 9, wherein
the toner refill cartridge includes:
a piston disposed in the body to be movable in a longitudinal direction of the body from a top dead position adjacent to a second end portion of the body to a bottom dead position adjacent to a first end portion of the body and to push the toner contained in the body toward the toner discharge port, and
a plunger to move the piston in the longitudinal direction, and
the piston includes a pressing protrusion to move the pressing member from the first position to the second when the piston is moved to the bottom dead position.

11. The image forming apparatus of claim 10, wherein
the toner refill cartridge includes an electric conductor supported by the pressing member,
the memory unit includes an internal electric contact which faces toward the body and is electrically connected to the external electric contact, and
the electric conductor is to contact the internal electric contact when the pressing member is at the first position and is to be separated from the internal electric contact when the pressing member is at the second position.

12. The image forming apparatus of claim 10, wherein
the plunger is movable to a folded position in which the plunger is parallel with the body and covers the external electric contact and to an extended position in which the plunger is aligned with the piston in the longitudinal direction.

13. The image forming apparatus of claim 12, wherein
the piston includes a first coupling portion, and
the plunger includes a second coupling portion coupled to the first coupling portion to lock the plunger at the extended position when the plunger is moved to the extended position.

14. The image forming apparatus of claim 12, wherein
the body includes a first portion to contain the toner and a second portion which extends in the longitudinal direction from the first portion and including the toner discharge port, and
the plunger includes a locking portion to be elastically locked with the second portion when the plunger is moved to the folded position.

15. The image forming apparatus of claim 12, wherein
the plunger includes a movement limiting protrusion to contact the second end portion of the body when the piston is moved to the bottom dead position.
